(19) United States
(12) Patent Application Publication
(10) Pub. No.: US 2019/0127111 A1
(43) Pub. Date: May 2, 2019

(54) Construct for Holding Articles, Associated Blank, and Method of Forming the Same

(71) Applicant: Graphic Packaging International, LLC, Atlanta, GA (US)

(72) Inventor: Matthew R. Kearns, Woodstock, GA (US)

(21) Appl. No.: 16/171,482

(22) Filed: Oct. 26, 2018

Related U.S. Application Data
(60) Provisional application No. 62/580,055, filed on Nov. 1, 2017.

(51) Int. Cl. B65D 5/50; A45C 11/16; B31B 50/26

(52) U.S. Cl. CPC B65D 5/5038; B31B 50/26; A45C 11/16

(57) ABSTRACT

A construct for engaging and supporting at least one article includes a plurality of panels and further includes retaining features. The plurality of panels extends around an interior of the construct and includes a central panel, a side panel, and an end panel, each of the side panel and the end panel foldably connected to the central panel. The retaining features are for engaging and supporting the at least one article, and provide access to the interior of the construct. The retaining features are reconfigurable between a first configuration in which the retaining features are substantially coplanar with the central panel and a second configuration in which the retaining features are at least partially recessed in the interior of the construct.

### CROSS-REFERENCE TO RELATED APPLICATION

This application claims the benefit of U.S. Provisional Patent Application No. 62/580,055, filed on Nov. 1, 2017.

### INCORPORATION BY REFERENCE

The disclosure of U.S. Provisional Patent Application No. 62/580,055, which was filed on Nov. 1, 2017, is hereby incorporated by reference for all purposes as if presented herein in its entirety.

### BACKGROUND OF THE DISCLOSURE

The present disclosure generally relates to a construct for holding at least one article. In embodiments, the present disclosure relates to a construct that has retaining features for engaging and supporting at least one jewelry item such as a ring.

### SUMMARY OF THE DISCLOSURE

According to one aspect of the disclosure, a construct for engaging and supporting at least one article comprises a plurality of panels and further comprises retaining features. The plurality of panels extends around an interior of the construct, the plurality of panels comprising a central panel, a side panel, and an end panel, each of the side panel and the end panel foldably connected to the central panel. The retaining features are for engaging and supporting the at least one article, the retaining features provide access to the interior of the construct and are reconfigurable between a first configuration in which the retaining features are substantially coplanar with the central panel and a second configuration in which the retaining features are at least partially recessed in the interior of the construct.

According to another aspect of the disclosure, a blank for forming a construct for engaging and supporting at least one article comprises a plurality of panels and further comprises retaining features. The plurality of panels comprises a central panel, a side panel, and an end panel, each of the side panel and the end panel foldably connected to the central panel. The retaining features are for engaging and supporting the at least one article in the construct formed from the blank, the retaining features provide access to the interior of the construct formed from the blank and are reconfigurable between a first configuration in which the retaining features are substantially coplanar with the central panel and a second configuration in which the retaining features are at least partially recessed away from the central panel.

According to another aspect of the disclosure, a method of forming a construct for engaging and supporting at least one article comprises obtaining a blank, the blank comprising a plurality of panels comprising a central panel, a side panel, and an end panel, each of the side panel and the end panel foldably connected to the central panel, the blank further comprising retaining features. The method further comprises folding the plurality of panels at least partially around an interior of the construct. The method further comprises reconfiguring the retaining features to receive the at least one article such that the retaining features are reconfigured between a first configuration in which the retaining features are substantially coplanar with the central panel and a second configuration in which the retaining features are at least partially recessed in the interior of the construct.

According to another aspect of the disclosure, a system for engaging and supporting at least one article comprises a construct and an outer container. The construct comprises a plurality of panels that extends around an interior of the construct, the plurality of panels comprising a central panel, a side panel, and an end panel, each of the side panel and the end panel foldably connected to the central panel. The construct further comprises retaining features for engaging and supporting the at least one article, the retaining features provide access to the interior of the construct and are reconfigurable between a first configuration in which the retaining features are substantially coplanar with the central panel and a second configuration in which the retaining features are at least partially recessed in the interior of the construct. The outer container of the system comprises a plurality of panels at least partially extending around an interior of the outer container, the construct is at least partially disposed in the interior of the outer container.

### BRIEF DESCRIPTION OF THE DRAWINGS

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an outer surface of a blank for forming a construct according to an exemplary embodiment of the disclosure.

FIG. 2 is a detail perspective view of a portion of the blank of FIG. 1.

FIG. 3 is a perspective view of a construct formed from the blank of FIG. 1 and provided with an outer container according to an exemplary embodiment of the disclosure.

FIG. 4 is a perspective view of a system including the construct of FIG. 3 at least partially received in the outer container.

FIG. 5 is a detail perspective view of a portion of the system of FIG. 4, with retaining features of the construct being reconfigured.

FIG. 6 is a perspective view of the system of FIG. 4, with an article supported and engaged by the retaining features of the construct.

Corresponding parts are designated by corresponding reference numbers throughout the drawings.

### DETAILED DESCRIPTION OF THE EXEMPLARY EMBODIMENTS

A construct according to the present disclosure can accommodate containers of numerous different shapes. In this specification, the terms “lower,” “bottom,” “upper,” “top,” “front,” and “back” indicate orientations determined in relation to fully erected construct.

As described herein, a construct may be formed by multiple overlapping panels, portions, and/or end flaps. Such panels, portions, and/or end flaps may be designated in relative terms to one another, e.g., “first”, “second”, “third”, etc., in sequential or non-sequential reference, without departing from the disclosure.

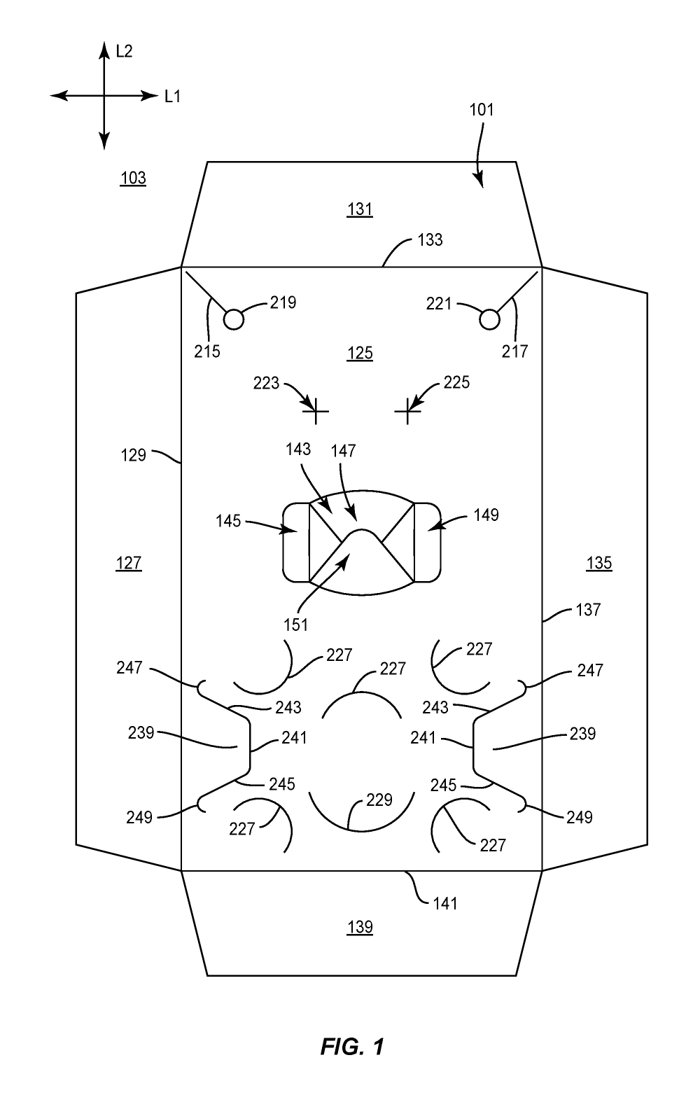

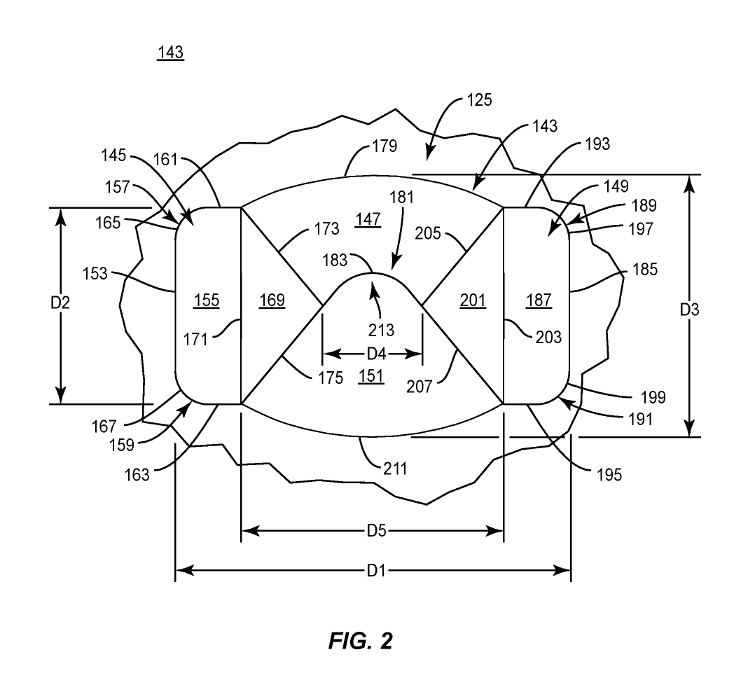

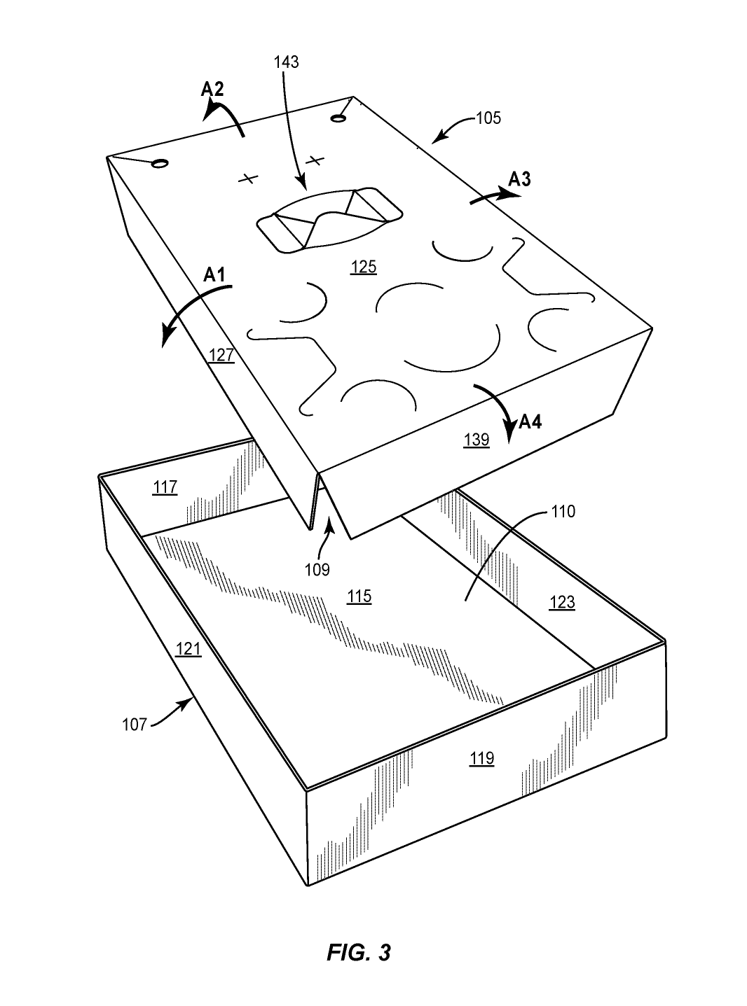

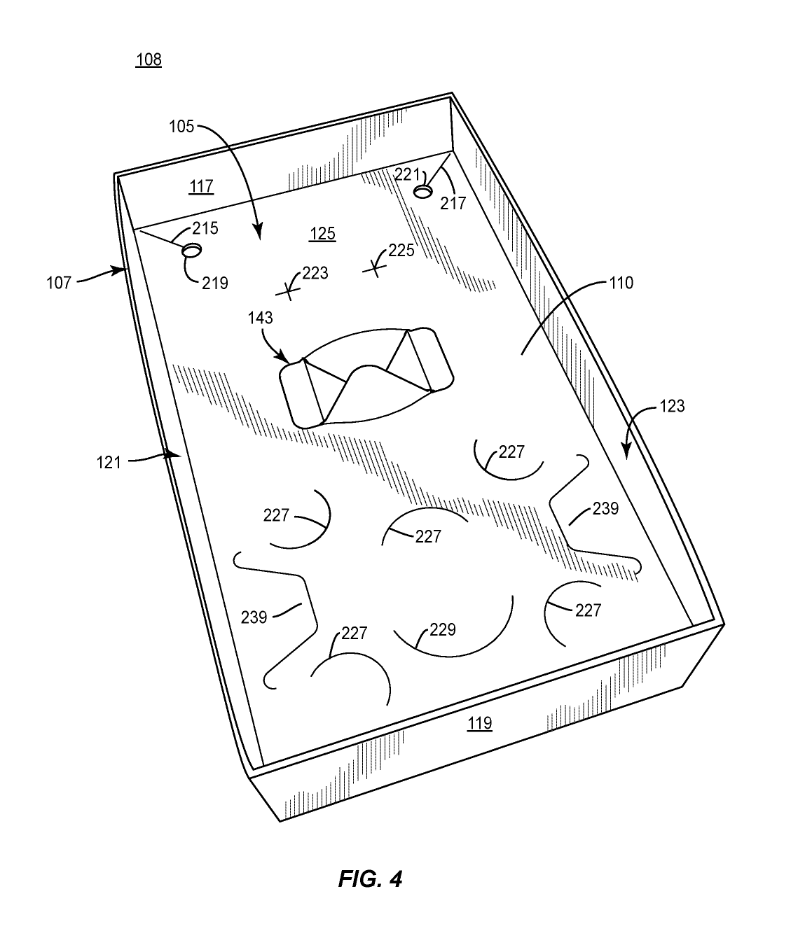

FIG. 1 shows a plan view of an exterior side 101 of a blank 103 used to form an insert or construct 105 (FIG. 3) in accordance with an exemplary embodiment of the disclosure. FIG. 2 shows an enlarged area of detail of the blank 103 that is identified in FIG. 1. As shown in FIGS. 3 and 4, the construct 105 has a configuration that can be at least partially received within an outer container, such as an outer container 107, to form a system 108. In embodiments, the outer container 107 may have the form of, for example, a box, a carton, a tray, a platform, a display, and/or a stand, to name a few. As shown in FIG. 4, the construct 105 is configured to be at least partially received within the outer container 107 such that the construct 105 can be provided for presentation, storage, and/or transport with the outer container 107. As also described herein, the construct 105 is provided with retaining features 143 that engage and support one or more article R such as a jewelry article, for example, a ring, band, or bracelet.

The blank 103, as shown, has a longitudinal axis L1 and a lateral axis L2. The illustrated blank 103 includes a top or central panel 125, a first side panel 127 foldably connected to the central panel 125 at a lateral fold line 129, a first end panel 131 foldably connected to the central panel 125 at a longitudinal fold line 133, a second side panel 135 foldably connected to the central panel 125 at a lateral fold line 137, and a second end panel 139 foldably connected to the central panel 125 at a longitudinal fold line 141.

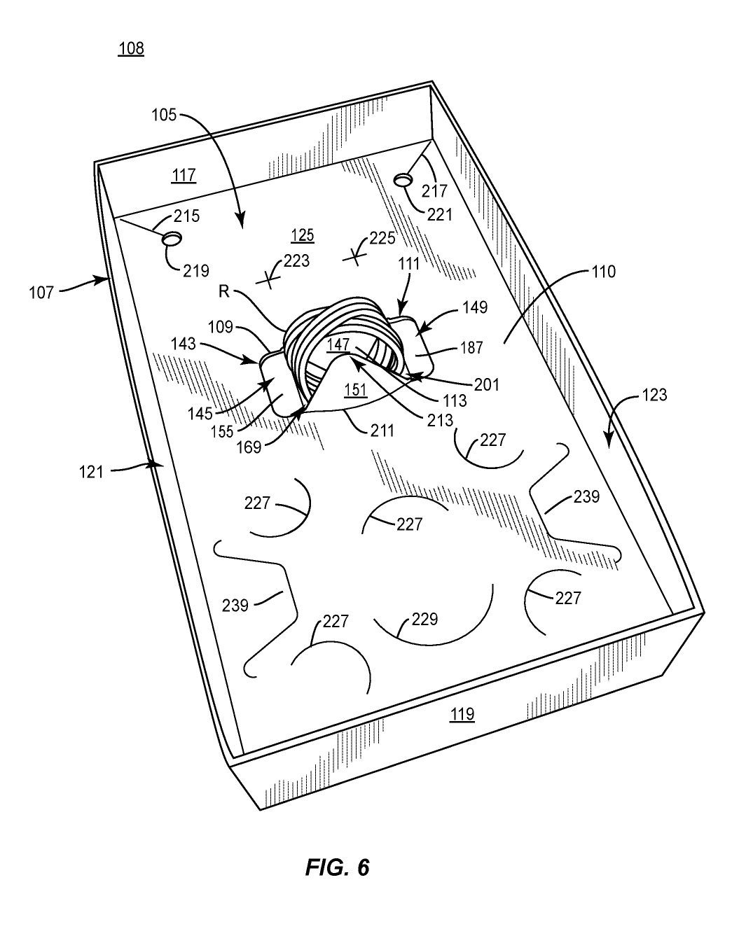

The central panel 125 includes retaining features 143 for engaging and supporting an article R (FIG. 6). The retaining features 143 include a first retaining flap 145, a second retaining flap 147, a third retaining flap 149, and a fourth retaining flap 151, each in at least partial facing relation with one another. Referring to FIGS. 1 and 2, the first retaining flap 145 is foldably connected to the central panel 125 at a lateral fold line 153 and includes a base portion 155 at least partially defined by a pair of J-shaped cuts 157, 159 having respective straight portions 161, 163 and respective curved portions 165, 167. The first retaining flap 145 also includes an extension 169 foldably connected to the base portion 155 at a lateral fold line 171 and defined by a pair of oblique cuts 173, 175 that intersect to provide a generally wedge-shaped or triangular configuration of the extension 169. In one embodiment, a relief cut can be collinearly disposed between portions of the fold line 171.

The second retaining flap 147, as shown, is at least partially foldably connected to the central panel 125 at a curved fold line 179, and is at least partially defined with a generally wedge-shaped or triangular configuration by the oblique cut 173 and another oblique cut 205, with a curved cut 183 extending from an endpoint of the oblique cut 173 to an endpoint of the oblique cut 205. In one embodiment, the curved fold line 179 can have endpoints that terminate at a location spaced away from respective end points the fold line 171 and a fold line 203 described herein. As also discussed herein, distal portion 181 of the second retaining flap 147, as shown, at least partially surrounds a protruding distal portion 213 of the fourth retaining flap 151.

The third retaining flap 149, as shown, is foldably connected to the central panel 125 at a lateral fold line 185 and includes a base portion 187 at least partially defined by a pair of J-shaped cuts 189, 191 having respective straight portions 193, 195 and respective curved portions 197, 199. The third retaining flap 149 also includes an extension 201 foldably connected to the base portion 187 at the lateral fold line 203 and defined by the oblique cut 205 and an oblique cut 207 that intersect to provide a generally wedge-shaped or triangular configuration of the extension 201. In one embodiment, a relief cut can be collinearly disposed between portions of the fold line 203.

The fourth retaining flap 151, as shown, is at least partially foldably connected to the central panel 125 at a curved fold line 211, and is at least partially defined with a generally wedge-shaped or triangular configuration by the intersection of the oblique cuts 207, 175 with the curved cut 183. A distal portion 213 of the fourth retaining flap 151 has a rounded or curved configuration at least partially defined by the curved cut 183, and extends past the point of intersection of the oblique cuts 173, 175 and the point of intersection of the oblique cuts 205, 207.

The retaining features 143 can be differently configured, for example, having one or more different shapes, dimensions, and/or configurations of lines of weakening, without departing from the disclosure.

The central panel 125, as shown, can be provided with other features for retaining other various articles. For example, oblique slits 215, 217 terminating in respective circular cuts 219, 221 can be provided for retaining portions of a jewelry article such as, for example, a necklace or chain. Cross-shaped cuts 223, 225, as shown, can be provided for retaining portions of a jewelry article such as, for example, earrings or pins. A series of cuts or other lines of weakening can be provided, as shown, for retaining one or more accessories jewelry articles such as, for example, bracelets, necklaces, brooches, rings, chains, pins, lockets, medallions, pendants, etc. As shown, the series of cuts for one or more accessory jewelry articles can include curved cuts 227, 229, and a pair of flaps 239 each at least partially defined by respective lateral cuts 241 intersected by respective oblique cuts 243, 245 having respective J-shaped cuts 247, 249 extending therefrom.

Referring to FIGS. 1-4, the first side panel 127 can be folded downwardly about the fold line 129 in the direction of the arrow A1, the first end panel 131 can be folded downwardly about the fold line 133 in the direction of the arrow A2, the second side panel 135 can be folded downwardly about the fold line 137 in the direction of the arrow A3, and the second end panel 139 can be folded downwardly about the fold line 141 in the direction of the arrow A4 to form the construct 105 and to define an interior 109 of the construct 105 below the central panel 125.

The construct 105 can be placed in an interior 110 of the outer container 107. As shown, the outer container 107 can include a bottom panel 115, end panels 117, 119 foldably connected to the bottom panel 115 and in a generally upright orientation with respect to the bottom panel 115, and side panels 121, 123 foldably connected to the bottom panel 115 and in a generally upright orientation with respect to the bottom panel 115. One or more of the end panels 117, 119 and the side panels 121, 123 can be connected, for example, by attachment flaps or other joining structure. The outer container 107 can have a different configuration without departing from the disclosure.

Upon receipt of the construct 105 in the interior 110 of the outer container 107, the central panel 125 is supported and raised in the interior 110 of the outer container 107 by the downwardly-extending first side panel 127, the first end panel 131, the second side panel 135, and the second end panel 139. In this regard, the central panel 125 is presented in an upward-facing orientation in the outer container 107, as shown. The construct 105 and the outer container 107 can together be provided as a system 108 according to the present disclosure. Alternatively, the central panel 125 can be integral with or part of the outer container 107, or the construct 105 and the outer container 107 can be provided separately, without departing from the disclosure.

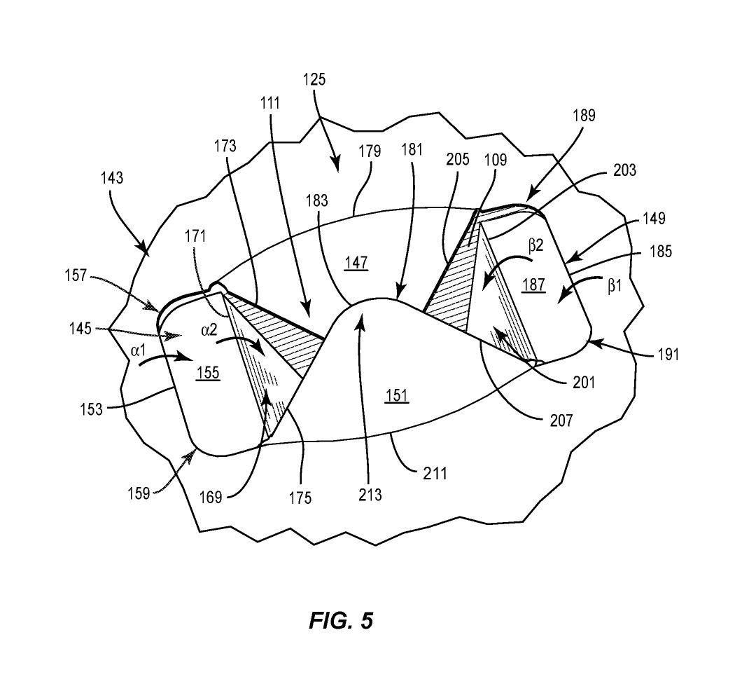

Referring additionally to the detail view of FIG. 5, the retaining features 143 are reconfigurable relative to the central panel 125 to accommodate an article R (FIG. 6). The retaining features 143 are reconfigurable between a first configuration, in which the retaining flaps 145, 147, 149, 151 are substantially coplanar with the central panel 125, and a second configuration in which one or more of the retaining flaps 145, 147, 149, 151 are at least partially recessed in the interior 109 of the construct 105/interior 110 of the outer container 108. In particular, the first retaining flap 145 can be at least partially separated from the central panel 125 at the cuts 157, 159, 173, 175 and the base portion 155 can be folded at least partially downwardly at the fold line 153 at an angle α1 measured relative to the central panel 125. Additionally, the extension 169 of the first retaining flap 145 can be folded at least partially downwardly relative to the base portion 155 at the fold line 171 at an angle α2 measured relative to the central panel 125. The angle α1 can be different than the angle α2 such that the base portion 155 and the extension 169 of the first retaining flap 145 can each be folded downwardly to a different angle relative to the central panel 125.

The second retaining flap 147, as shown, can be at least partially separated from the central panel 125 at the cuts 173, 205, 183, and can be at least partially folded downwardly at the fold line 179.

The third retaining flap 149, as shown, can be at least partially separated from the central panel 125 at the cuts 189, 191, 205, 207 and the base portion 187 can be at least partially downwardly at the fold line 185 at an angle f31 measured relative to the central panel 125. Additionally, the extension 201 of the third retaining flap 149 can be folded at least partially downwardly relative to the base portion 187 at the fold line 203 at an angle f32 measured relative to the central panel 125. The angle f31 can be different than the angle 132 such that the base portion 187 and the extension 201 of the third retaining flap 149 can each be folded downwardly to a different angle relative to the central panel 125.

The fourth retaining flap 151, as shown, can be at least partially separated from the central panel 125 at the cuts 207, 175, 183, and can be at least partially folded downwardly at the fold line 211.

In this regard, the retaining features 143 can be reconfigured to provide a recess 111 for access into the interior 109 of the construct 105 and the interior 110 of the outer container 107 to at least partially receive an article R (FIG. 6). It will be understood that one or more of the angles α1, α2, β1, β2 can be nonzero angles, e.g., oblique angles or right angles. While the reconfiguration of the retaining features 143 has been described above as prior to the introduction of the article R for clarity of illustration, it will be understood that the introduction of the article R and engagement of the article R with the retaining flaps 145, 147, 149, 151 can cause the reconfiguration and downward folding thereof.

Turning additionally to FIG. 6, the article R is shown at least partially received in the recess 111 and in a generally upright configuration. The article R, as shown, is a ring, e.g., an annular member, such that a central opening 113 is defined therethrough. As shown, following introduction of the article R into the recess 111, the second retaining flap 147 and the fourth retaining flap 151 can cam or otherwise pass over the lower portion of the article R and can be biased to return to a resting position that is elevated above the extensions 169, 201 and at least partially extending through the central opening 113 of the article R. The distal portion 181 of the second retaining flap 147 and the distal portion 213 of the fourth retaining flap 151, each having a generally wedge-shaped or triangular configuration, intersect the article R along one or more portions thereof to stabilize and support the position of the article R in the recess 111. For example, portions of the second retaining flap 147 defined along one or both of the oblique cuts 173, 205 and/or portions of the fourth retaining flap 151 defined along one or both of the oblique cuts 175, 207 can engage interior edges or surfaces of the article R. In one embodiment, the second retaining flap 147 and the fourth retaining flap 151 can be biased to return to a resting position, e.g., a raised or substantially planar relationship with the central panel 125, under the influence of the respective fold lines 179, 211. In one embodiment, the distal portion 181 of the second retaining flap 147 and the distal portion 213 of the fourth retaining flap 151 are configured to interengage in a raised position, for example, through frictional edge-to-edge contact or a slight overlap of the distal portions 181, 213.

Still referring to FIGS. 2, 5, and 6, the first retaining flap 145 and the third retaining flap 149 are positioned to engage and support outer portions of the article R. In particular, the extensions 169, 201 of the respective first retaining flap 145 and the third retaining flap 149 obliquely engage the outer sides of the article R. It will be understood that the retaining features 143 can accommodate an article R having dimensions larger or smaller than those shown, for example, through engagement of at least the respective base portions 155, 187 and the respective extensions 169, 201 of the respective first retaining flap 145 and the third retaining flap 149 with the outer sides of the article R.

As described above, portions of the retaining features 143 are provided with variable geometries, for example, the oblique cuts 173, 205 that provide the generally triangular or wedge-shaped configuration of the second retaining flap 147, the oblique cuts 207, 175 that provide the generally triangular configuration of the fourth retaining flap 151, and the angles α1, α2 and β1, β2 through which portions of the respective first retaining flap 145 and the third retaining flap 149 move to accommodate the article R. In this regard, the retaining features 143 are reconfigurable based on a size of an article to engage and support different articles having different dimensions, e.g., inner diameter, outer diameter, thickness, and width. For example, the angles α1, α2 and β1, β2 of the portions of the respective first retaining flap 145 and the third retaining flap 149 can increase or decrease upon reconfiguration of the retaining features 143 to accommodate articles R of different sizes such that the construct 105/system 108 can be provided to receive articles R of multiple different sizes. Such reconfigurable and adaptable properties are advantageous at least to provide a construct 105/system 108 that can accommodate a range of products such as articles R. In one embodiment, the retaining features 143 are configured to engage and support an article within a predetermined range of sizes, for example, an outer diameter D1 (corresponding to a longitudinal distance from the fold line 153 to the fold line 185) of up to and including about 1.5 inches and a thickness or width D2 (corresponding to a lateral distance from the cuts 161, 193 to the cuts 163, 195) of up to and including about 0.75 inches (FIG. 2). If such article has an annular configuration, such as that of article R or another ring, the retaining features 143 can engage and support the article having a minimum inner diameter D4 (corresponding to a longitudinal distance from an endpoint of the cut 173 to an endpoint of the cut 205) of about 0.125 inches and up to a maximum inner diameter D5 (corresponding to a longitudinal distance from the fold line 171 to the fold line 203) of about 0.8 inches. At least a central portion of such article can have a predetermined thickness or width D3 (corresponding to a lateral distance from the center of the curved fold line 179 to the center of the curved fold line 211) that is greater than D2, for example, up to and including about 1.0 inches. It will be understood that the dimensions D1, D2, D3, D4, and/or D5 can correspond to a different range of predetermined sizes of an article, for example, to accommodate differently-sized, e.g., larger or smaller articles, without departing from the disclosure. For example, in one embodiment, an article can have an outer diameter D1 of between about 0.3 inches and about 3.5 inches, a thickness or width D2 and/or D3 of between about 0.07 inches and about 5.75 inches, and an inner diameter D4/D5 between about 0.2 inches and about 3.4 inches, or any integer or non-integer number therebetween.

In general, the blank may be constructed from paperboard having a caliper so that it is heavier and more rigid than ordinary paper. The blank can also be constructed of other materials, such as cardboard, or any other material having properties suitable for enabling the construct to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the construct embodiments. The term “glue” is intended to encompass all manner of adhesives commonly used to secure construct panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A construct for engaging and supporting at least one article, the construct comprising:
a plurality of panels extending around an interior of the construct, the plurality of panels comprising a central panel, a side panel, and an end panel, each of the side panel and the end panel foldably connected to the central panel; and
retaining features for engaging and supporting the at least one article, the retaining features provide access to the interior of the construct and are reconfigurable between a first configuration in which the retaining features are substantially coplanar with the central panel and a second configuration in which the retaining features are at least partially recessed in the interior of the construct.

2. The construct of claim 1, wherein the retaining features are configured to retain the at least one article having a size within a predetermined range of sizes.

3. The construct of claim 1, wherein the retaining features comprise a first retaining flap and a second retaining flap each foldably connected to the central panel.

4. The construct of claim 3, wherein the first retaining flap comprises a base portion and an extension foldably connected to the base portion.

5. The construct of claim 4, wherein when the retaining features are in the second configuration, the extension is disposed at an oblique angle relative to the base portion.

6. The construct of claim 5, wherein when the retaining features are in the second configuration, the base portion is disposed at an oblique angle relative to the central panel.

7. The construct of claim 6, wherein when the retaining features are in the second configuration, the second retaining flap is elevated above the extension.

8. The construct of claim 7, wherein when the retaining features are in the second configuration, the second retaining flap is biased toward a resting position.

9. The construct of claim 1, wherein the retaining features comprise a first retaining flap and a second retaining flap each foldably connected to the central panel, the second retaining flap is foldably connected to the central panel at a curved fold line.

10. The construct of claim 9, wherein each of the first retaining flap and the second retaining flap is at least partially defined by a pair of oblique cuts.

11. The construct of claim 10, wherein the second retaining flap is at least partially defined by a curved cut.

12. The construct of claim 9, wherein the retaining features further comprise a third retaining flap and a fourth retaining flap each foldably connected to the central panel.

13. The construct of claim 12, wherein the first retaining flap, the second retaining flap, the third retaining flap, and the fourth retaining flap are disposed in at least partially facing relation.

14. The construct of claim 12, wherein the third retaining flap comprises a base portion and an extension foldably connected to the base portion, and the fourth retaining flap is foldably connected to the central panel at a curved fold line.

15. The construct of claim 14, wherein the third retaining flap and the fourth retaining flap are each at least partially defined by a pair of oblique cuts, and the fourth retaining flap is at least partially defined by a curved cut.

16. A blank for forming a construct for engaging and supporting at least one article, the blank comprising:
a plurality of panels comprising a central panel, a side panel, and an end panel, each of the side panel and the end panel foldably connected to the central panel; and
retaining features for engaging and supporting the at least one article in the construct formed from the blank, the retaining features provide access to the interior of the construct formed from the blank and are reconfigurable between a first configuration in which the retaining features are substantially coplanar with the central panel and a second configuration in which the retaining features are at least partially recessed away from the central panel.

17. The blank of claim 16, wherein the retaining features are configured to retain the at least one article having a size within a predetermined range of sizes.

18. The blank of claim 16, wherein the retaining features comprise a first retaining flap and a second retaining flap each foldably connected to the central panel.

19. The blank of claim 18, wherein the first retaining flap comprises a base portion and an extension foldably connected to the base portion.

20. The blank of claim 16, wherein the retaining features comprise a first retaining flap and a second retaining flap each foldably connected to the central panel, the second retaining flap is foldably connected to the central panel at a curved fold line.

21. The blank of claim 20, wherein each of the first retaining flap and the second retaining flap is at least partially defined by a pair of oblique cuts.

22. The blank of claim 21, wherein the second retaining flap is at least partially defined by a curved cut.

23. The blank of claim 20, wherein the retaining features further comprise a third retaining flap and a fourth retaining flap each foldably connected to the central panel.

24. The blank of claim 23, wherein the first retaining flap, the second retaining flap, the third retaining flap, and the fourth retaining flap are disposed in at least partially facing relation.

25. The blank of claim 23, wherein the third retaining flap comprises a base portion and an extension foldably connected to the base portion, and the fourth retaining flap is foldably connected to the central panel at a curved fold line.

26. The blank of claim 25, wherein the third retaining flap and the fourth retaining flap are each at least partially defined by a pair of oblique cuts, and the fourth retaining flap is at least partially defined by a curved cut.

27. A method of forming a construct for engaging and supporting at least one article, the method comprising:
obtaining a blank, the blank comprising a plurality of panels comprising a central panel, a side panel, and an end panel, each of the side panel and the end panel foldably connected to the central panel, the blank further comprising retaining features;
folding the plurality of panels at least partially around an interior of the construct;
reconfiguring the retaining features to receive the at least one article such that the retaining features are reconfigured between a first configuration in which the retaining features are substantially coplanar with the central panel and a second configuration in which the retaining features are at least partially recessed in the interior of the construct.

28. The method of claim 27, wherein the retaining features are configured to retain the at least one article having a size within a predetermined range of sizes.

29. The method of claim 27, wherein the retaining features comprise a first retaining flap and a second retaining flap each foldably connected to the central panel.

30. The method of claim 29, wherein the first retaining flap comprises a base portion and an extension foldably connected to the base portion.

31. The method of claim 30, wherein when the retaining features are in the second configuration, the extension is disposed at an oblique angle relative to the base portion.

32. The method of claim 31, wherein when the retaining features are in the second configuration, the base portion is disposed at an oblique angle relative to the central panel.

33. The method of claim 32, wherein when the retaining features are in the second configuration, the second retaining flap is elevated above the extension.

34. The method of claim 33, wherein when the retaining features are in the second configuration, the second retaining flap is biased toward a resting position.

35. The method of claim 27, wherein the retaining features comprise a first retaining flap and a second retaining flap each foldably connected to the central panel, the second retaining flap is foldably connected to the central panel at a curved fold line.

36. The method of claim 35, wherein each of the first retaining flap and the second retaining flap is at least partially defined by a pair of oblique cuts.

37. The method of claim 36, wherein the second retaining flap is at least partially defined by a curved cut.

38. The method of claim 35, wherein the retaining features further comprise a third retaining flap and a fourth retaining flap each foldably connected to the central panel.

39. The method of claim 38, wherein the first retaining flap, the second retaining flap, the third retaining flap, and the fourth retaining flap are disposed in at least partially facing relation.

40. The method of claim 38, wherein the third retaining flap comprises a base portion and an extension foldably connected to the base portion, and the fourth retaining flap is foldably connected to the central panel at a curved fold line.

41. The method of claim 40, wherein the third retaining flap and the fourth retaining flap are each at least partially defined by a pair of oblique cuts, and the fourth retaining flap is at least partially defined by a curved cut.

42. A system for engaging and supporting at least one article, the system comprising:
a construct, the construct comprising:
a plurality of panels extending around an interior of the construct, the plurality of panels comprising a central panel, a side panel, and an end panel, each of the side panel and the end panel foldably connected to the central panel; and
retaining features for engaging and supporting the at least one article, the retaining features provide access to the interior of the construct and are reconfigurable between a first configuration in which the retaining features are substantially coplanar with the central panel and a second configuration in which the retaining features are at least partially recessed in the interior of the construct; and
the outer container comprising a plurality of panels at least partially extending around an interior of the outer container, the construct at least partially disposed in the interior of the outer container.

43. The system of claim 42, wherein the retaining features are configured to retain the at least one article having a size within a predetermined range of sizes.

44. The system of claim 42, wherein the retaining features comprise a first retaining flap and a second retaining flap each foldably connected to the central panel.

45. The system of claim 44, wherein the first retaining flap comprises a base portion and an extension foldably connected to the base portion.

46. The system of claim 45, wherein when the retaining features are in the second configuration, the extension is disposed at an oblique angle relative to the base portion.

47. The system of claim 46, wherein when the retaining features are in the second configuration, the base portion is disposed at an oblique angle relative to the central panel.

48. The system of claim 47, wherein when the retaining features are in the second configuration, the second retaining flap is elevated above the extension.

49. The system of claim 48, wherein when the retaining features are in the second configuration, the second retaining flap is biased toward a resting position.

50. The system of claim 42, wherein the retaining features comprise a first retaining flap and a second retaining flap each foldably connected to the central panel, the second retaining flap is foldably connected to the central panel at a curved fold line.

51. The system of claim 50, wherein each of the first retaining flap and the second retaining flap is at least partially defined by a pair of oblique cuts.

52. The system of claim 51, wherein the second retaining flap is at least partially defined by a curved cut.

53. The system of claim 50, wherein the retaining features further comprise a third retaining flap and a fourth retaining flap each foldably connected to the central panel.

54. The system of claim 53, wherein the first retaining flap, the second retaining flap, the third retaining flap, and the fourth retaining flap are disposed in at least partially facing relation.

55. The system of claim 53, wherein the third retaining flap comprises a base portion and an extension foldably connected to the base portion, and the fourth retaining flap is foldably connected to the central panel at a curved fold line.

56. The system of claim 55, wherein the third retaining flap and the fourth retaining flap are each at least partially defined by a pair of oblique cuts, and the fourth retaining flap is at least partially defined by a curved cut.
